(19) United States
(12) Patent Application Publication
(10) Pub. No.: US 2025/0037125 A1
(43) Pub. Date: Jan. 30, 2025

(54) GENERATING EVENT-BASED TOKENS TRANSPARENT TO A NETWORK

(71) Applicant: Plaid Inc., San Francisco, CA (US)

(72) Inventors: Jordana COHEN, New York, NY (US); William ROWAN, Incline Village, NV (US); Rron REXHA, New York, NY (US)

(21) Appl. No.: 18/783,144

(22) Filed: Jul. 24, 2024

Related U.S. Application Data
(60) Provisional application No. 63/515,495, filed on Jul. 25, 2023.

(51) Int. Cl. G06Q 20/40; G06Q 20/02; G06Q 20/38

(52) U.S. Cl. CPC G06Q 20/401; G06Q 20/023; G06Q 20/3825

(57) ABSTRACT

In some implementations, a tokenizer may receive, from a registered device, an authorization request for account information, in a format associated with a network, to use for an event. The tokenizer may generate a token, transparent to the format associated with the network and based on the account information, where the token expires after a single use for the event. The tokenizer may transmit the token to the registered device in response to the authorization request. The tokenizer may transmit an indication associated with the token to a processing device included in the network.

### CROSS-REFERENCE TO RELATED APPLICATION

This application claims priority to U.S. Provisional Patent Application No. 63/515,495, filed Jul. 25, 2023, which is incorporated herein by reference in its entirety.

### BACKGROUND

Sensitive information, such as account numbers, may be transmitted on a network in order to enable a transaction. However, the sensitive information is vulnerable when transmitted between devices. For example, a bad actor may intercept the sensitive information and use the sensitive information to generate fraudulent transactions. Undoing fraudulent transactions and changing account numbers in response to fraudulent transactions consumes power, processing resources, and network overhead.

### SUMMARY

Some implementations described herein relate to a system for generating transparent tokens in response to events. The system may include one or more memories and one or more processors communicatively coupled to the one or more memories. The one or more processors may be configured to receive, from a registered device, an authorization request for account information, in a format associated with a network, to use for an event. The one or more processors may be configured to generate a token, transparent to the format associated with the network and based on the account information, wherein the token expires after a single use for the event. The one or more processors may be configured to transmit the token to the registered device in response to the authorization request. The one or more processors may be configured to receive, from a processing device included in the network, a detokenization request including the token. The one or more processors may be configured to transmit, to the processing device, the account information in response to the detokenization request. The one or more processors may be configured to store an indication that the token is expired based on transmitting the account information.

Some implementations described herein relate to a method of generating transparent tokens in response to events. The method may include receiving, from a registered device, an authorization request for account information, in a format associated with a network, to use for an event. The method may include generating a token, transparent to the format associated with the network and based on the account information, wherein the token expires after a single use for the event. The method may include transmitting the token to the registered device in response to the authorization request. The method may include transmitting an indication associated with the token to a processing device included in the network.

Some implementations described herein relate to a non-transitory computer-readable medium that stores a set of instructions for generating transparent tokens in response to events. The set of instructions, when executed by one or more processors of a device, may cause the device to generate, for an account, a persistent identifier unique to the device. The set of instructions, when executed by one or more processors of the device, may cause the device to receive, from a registered device, a first authorization request for account information, in a format associated with a network, to use for a first event. The set of instructions, when executed by one or more processors of the device, may cause the device to generate a first token, transparent to the format associated with the network and based on the account information, wherein the first token expires after a single use for the first event. The set of instructions, when executed by one or more processors of the device, may cause the device to transmit the first token to the registered device, in response to the first authorization request, with the persistent identifier. The set of instructions, when executed by one or more processors of the device, may cause the device to receive, from the registered device, a second authorization request for the account information, in the format associated with the network, to use for a second event. The set of instructions, when executed by one or more processors of the device, may cause the device to generate a second token, transparent with the format associated with the network and based on the account information, wherein the second token expires after a single use for the second event. The set of instructions, when executed by one or more processors of the device, may cause the device to transmit the second token to the registered device, in response to the first authorization request, with the persistent identifier.

### BRIEF DESCRIPTION OF THE DRAWINGS

FIGS. 1A-1C are diagrams of an example implementation relating to generating event-based tokens transparent to a network.

FIGS. 2A-2D are diagrams of an example implementation relating to generating persistent identifiers.

FIG. 3 is a diagram of an example environment in which systems and/or methods described herein may be implemented.

FIG. 4 is a diagram of example components of one or more devices of FIG. 3.

FIG. 5 is a flowchart of an example process relating to generating event-based tokens transparent to a network.

### DETAILED DESCRIPTION

The following detailed description of example implementations refers to the accompanying drawings. The same reference numbers in different drawings may identify the same or similar elements.

Account information, such as account numbers, routing numbers, and/or other identifiers, may be transmitted on a network in order to enable a transaction. For example, the account information may be included in a national automated clearing house association (NACHA) file and transmitted across devices associated with an automated clearing house (ACH) network. However, the account information is unsecure; for example, a bad actor may intercept the account information and use the account information to generate fraudulent transactions. Undoing fraudulent transactions, as well as changing account information in response to fraudulent transactions, consumes power, processing resources, and network overhead.

In order to improve security, some data providers (e.g., managers of accounts on behalf of users) may tokenize account information. As a result, different devices associated with the ACH network (e.g., different merchant devices and/or other devices authorized to perform transactions) may receive different tokens, even when using same account information. However, because a merchant device uses a same token repeatedly, the token may still be intercepted and used for fraudulent transactions because the token is persistent. As noted, undoing fraudulent transactions, as well as changing account information in response to fraudulent transactions, consumes power, processing resources, and network overhead.

Some implementations described herein enable generation of single use tokens that are transparent to a network (e.g., an ACH network). For example, the tokens may be generated in response to a request for a single event (e.g., a single transaction) and expire after one use. As a result, security is improved because the tokens are useless if intercepted because the tokens are not persistent. Additionally, power, processing resources, and network overhead are conserved that otherwise would have been spent on undoing fraudulent transactions.

As noted above, some data providers may still tokenize account information. Accordingly, a device associated with the ACH network (e.g., a merchant device and/or another device authorized to perform transactions) may be unable to determine whether a first event (e.g., a first transaction) is associated with a same account as a second event (e.g., a second transaction) when a data provider provides different tokens for the events. For example, the account may have been disconnected and reconnected to the merchant device between events such that the data provider generated a new token during reconnection. In another example, the merchant device may receive single use tokens, as described herein, such that each event is associated with a new token. Therefore, the merchant device is less likely to proactively detect and prevent fraud (e.g., repeat events or transactions). As noted, undoing fraudulent transactions, as well as changing account information in response to fraudulent transactions, consumes power, processing resources, and network overhead.

Some implementations described herein enable generation of persistent identifiers to associate with tokenized account information. For example, a persistent identifier may be provided, along with a token, to a device associated with the ACH network (e.g., a merchant device and/or another device authorized to perform transactions). As a result, the merchant device may determine when events (e.g., transactions) are associated with a same account and thus is more likely to proactively detect and prevent fraud (e.g., repeat events or transactions). Therefore, power, processing resources, and network overhead are conserved that otherwise would have been spent on undoing fraudulent transactions. Additionally, security is improved because the persistent identifier is only for informational purposes and is unusable in place of the token.

In some implementations, data providers may tokenize account information, even when single use tokens are used, such that the single use tokens are generated based on persistent tokens. As a result, a persistent identifier allows a device associated with the ACH network to determine when events (e.g., transactions) are associated with a same account even through two layers of tokenization. As noted, security is improved because the persistent identifier is only for informational purposes and is unusable in place of the tokens.

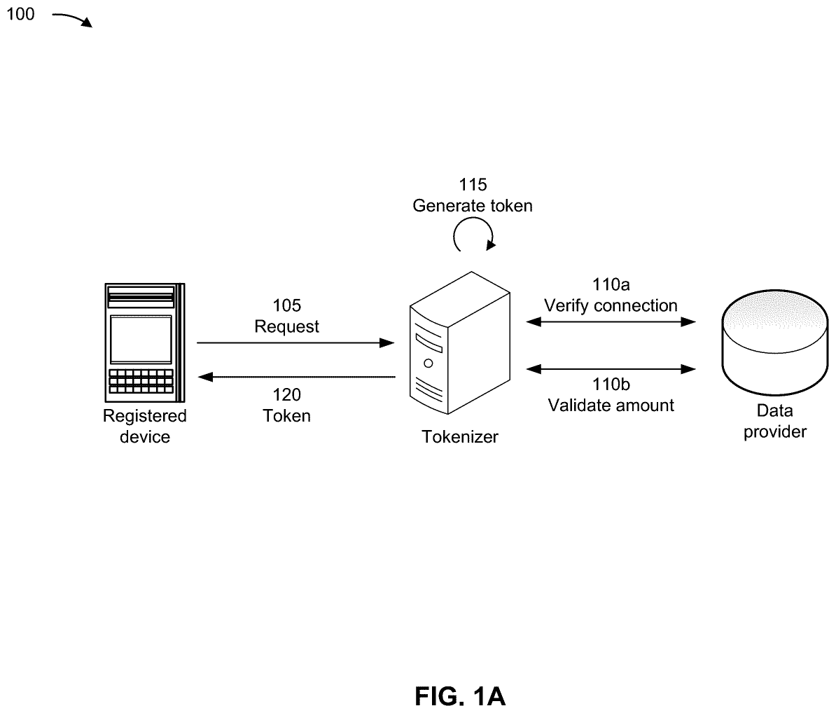

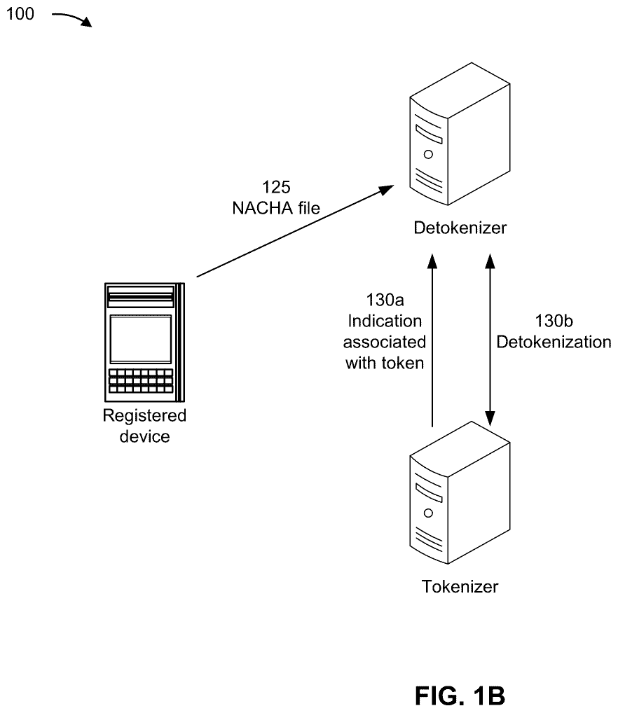

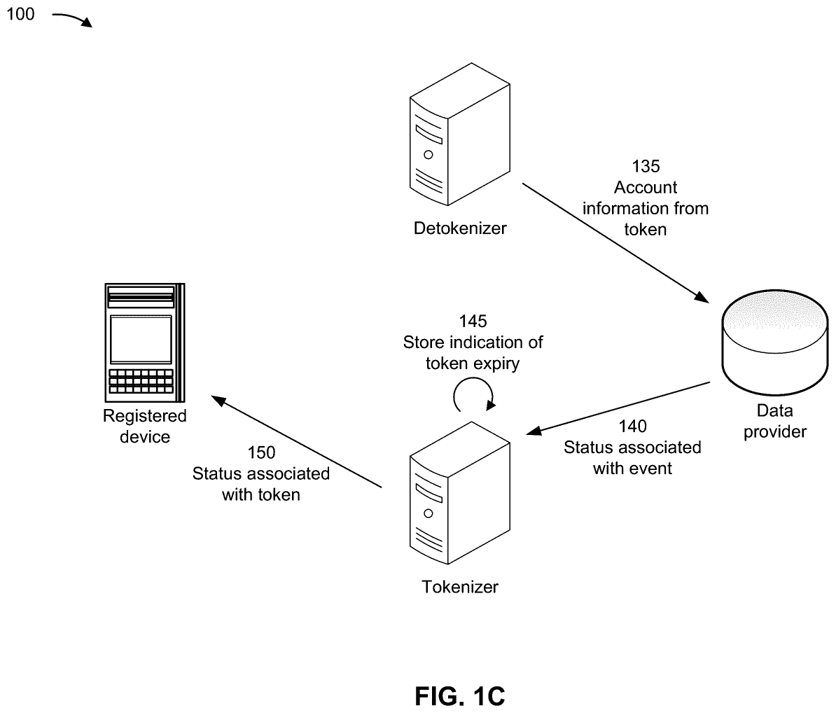

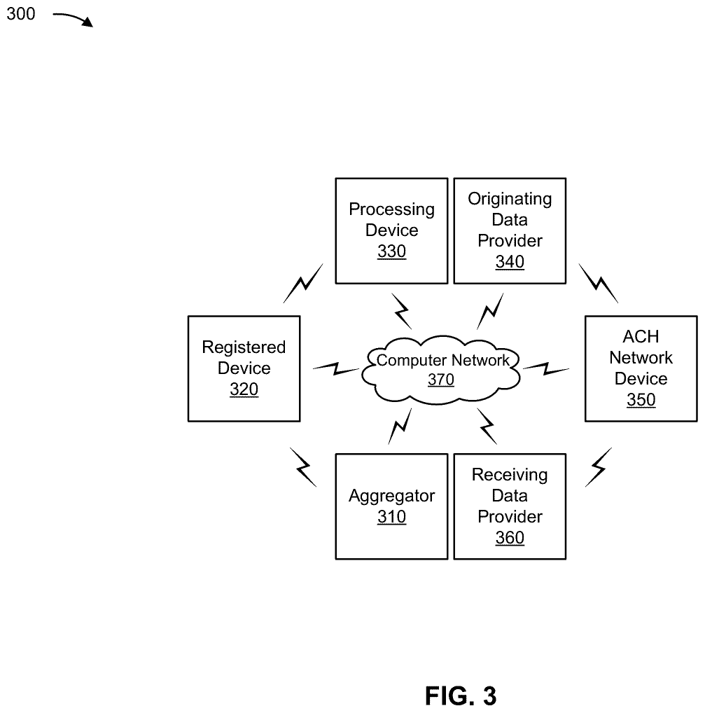

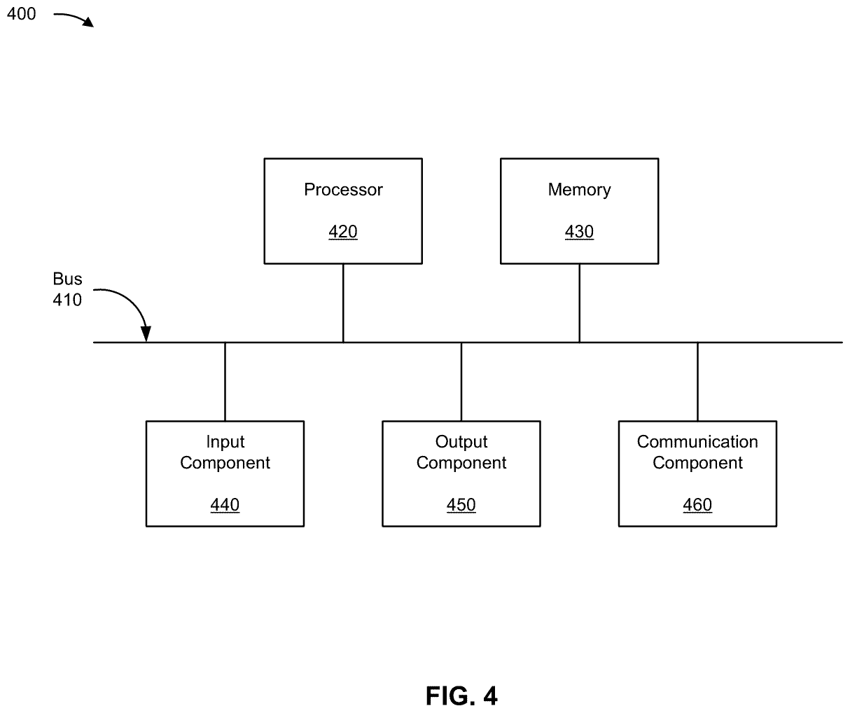

FIGS. 1A-1C are diagrams of an example 100 associated with generating event-based tokens transparent to a network. As shown in FIGS. 1A-1C, example 100 includes a registered device, a tokenizer, a data provider, and a detokenizer. These devices are described in more detail in connection with FIGS. 3 and 4.

As shown in FIG. 1A and by reference number 105, the registered device may transmit, and the tokenizer may receive, an authorization request for account information. The tokenizer may be an aggregator, as described in connection with FIG. 3. Alternatively, the tokenizer may be a receiving data provider, as described in connection with FIG. 3. As shown in FIG. 1A, the tokenizer may receive the request directly from the registered device. Alternatively, the registered device may transmit the request to an aggregator that forwards the request (e.g., directly or by decoding the request and generating a new request based on information decoded from the request) to the tokenizer (e.g., a receiving data provider). Alternatively, the registered device may transmit the request to a receiving data provider that forwards the request (e.g., directly or by decoding the request and generating a new request based on information decoded from the request) to the tokenizer (e.g., an aggregator).

The request may be in a format associated with a network. For example, the network may include an ACH network, and the format may include an ACH format (e.g., a NACHA file format or another format associated with an ACH network). The request may be associated with an event. For example, the request may be associated with a transaction (e.g., a debit or credit of funds to an account managed by the receiving data provider). In another example, the request may be associated with an informational request (e.g., a balance pull and/or a pull of historical transaction information, among other examples).

In response to the request, the tokenizer may perform verifications (e.g., at least one verification) and/or validations (e.g., at least one validation). For example, as shown by reference number 110a, the tokenizer may verify a connection, between the registered device and an account associated with the account information, in response to the request. In one example, the tokenizer may be an aggregator that connects the registered device to accounts that have been connected to the registered device by users that manage the accounts. Accordingly, the tokenizer may communicate with the data provider, associated with the account, to confirm that a user managing the account has not disconnected the registered device from the account. In another example, the tokenizer may be at least partially integrated (e.g., physically, logically, and/or virtually) with the data provider. Accordingly, the tokenizer may confirm that a user managing the account has not instructed the data provider to disconnect the registered device from the account. By verifying the connection before generating a token (as described in connection with reference number 115), the tokenizer reduces chances that the event will fail to proceed despite using the token. As a result, the tokenizer conserves power, processing resources, and network overhead that would have been wasted in processing the event without success.

Additionally, or alternatively, as shown by reference number 110b, the tokenizer may validate an amount (e.g., indicated in the request) against a balance associated with the account information. For example, the request may indicate a dollar amount (e.g., $20 or $20.12, among other examples) associated with the event. The tokenizer may transmit, and the data provider may receive, a balance request. Accordingly, the data provider may transmit, and the tokenizer may receive, a response to the balance request that indicates the balance associated with the account information. Therefore, the tokenizer may validate the amount against the balance (e.g., validate that the balance is equal to, or larger than, the amount). In examples where the tokenizer is at least partially integrated (e.g., physically, logically, and/or virtually) with the data provider, the tokenizer may validate the balance directly (e.g., without transmitting a balance request). By validating the amount against the balance before generating a token (as described in connection with reference number 115), the tokenizer reduces chances that the event will fail to proceed despite using the token. As a result, the tokenizer conserves power, processing resources, and network overhead that would have been wasted in processing the event without success. In order to further increase chances of success, the tokenizer may transmit, and the data provider may receive, a hold request for at least a portion of the balance equal to the amount during processing of the event (e.g., for a few days). In examples where the tokenizer is at least partially integrated (e.g., physically, logically, and/or virtually) with the data provider, the tokenizer may hold at least a portion of the balance directly (e.g., without transmitting a hold request).

As shown by reference number 115, the tokenizer may generate a token based on the account information. For example, the tokenizer may replace an account number with a tokenized account number, a routing number with a tokenized routing number, and/or an account name with a tokenized account name. In some implementations, the tokenizer generates the token based on the validation and/or the verification described above (e.g., validation of the amount against the balance and/or verification of the connection).

The token is transparent to the format associated with the network. As used herein, “transparent” refers to a same type and length of data (e.g., using an integer where the format uses an integer and using a same quantity of digits as the format). For example, the tokenized routing number may be a nine-digit number that is transparent to the ACH network. In some implementations, the tokenized routing number may be a valid routing number (e.g., satisfying a checksum condition and registered with an ACH registrar, such as Accuity) that is associated with tokenization (e.g., according to a data structure associating the routing number with an indication of tokenization). Alternatively, the tokenized routing number may be an invalid routing number (e.g., violating the checksum condition and/or unregistered with the ACH registrar) that thus indicates tokenization through invalidity.

Similarly, the tokenized account number may have a prefix, a postfix, a midfix, or another portion that is associated with tokenization (e.g., according to a data structure associating the portion with an indication of tokenization). Additionally, or alternatively, the tokenized account number may indicate tokenization by satisfying a condition (e.g., a checksum condition).

The token expires after a single use for the event. As a result, security is improved because the token is unable to be reused (also referred to as a “replay attack”). Because the token is not persistent, the token is useless if intercepted. As a result, power, processing resources, and network overhead are conserved that otherwise would have been spent on undoing fraudulent transactions perpetuated with the intercepted token.

In some implementations, the token further expires based on an expiry threshold of three days or less. For example, the token may expire based on the registered device failing to use the token to proceed with the event (e.g., submit the transaction for processing). As a result, security is further improved because the token is useless if intercepted after the expiry threshold is satisfied. Therefore, power, processing resources, and network overhead are conserved that otherwise would have been spent on undoing fraudulent transactions perpetuated with the intercepted token.

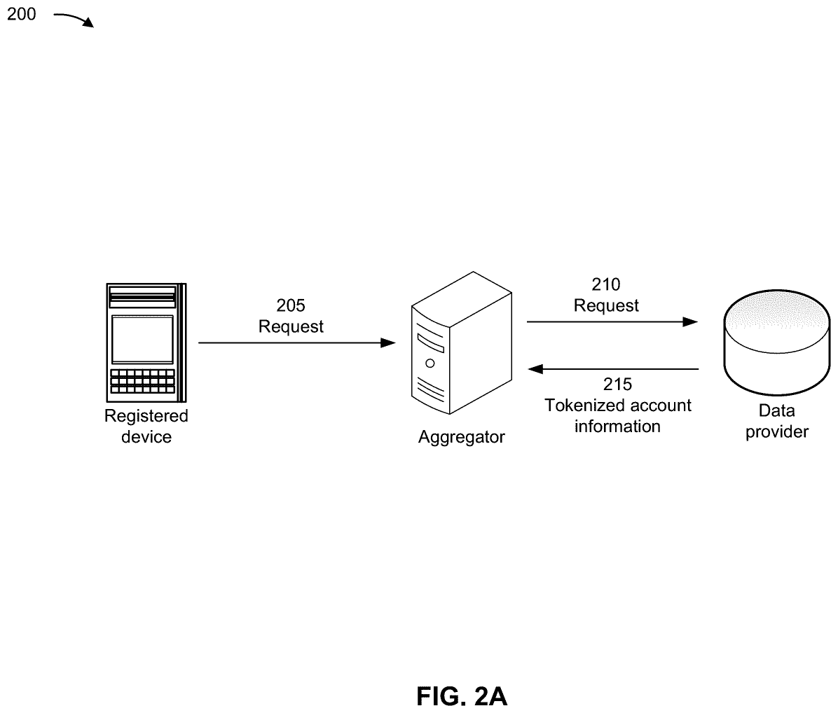

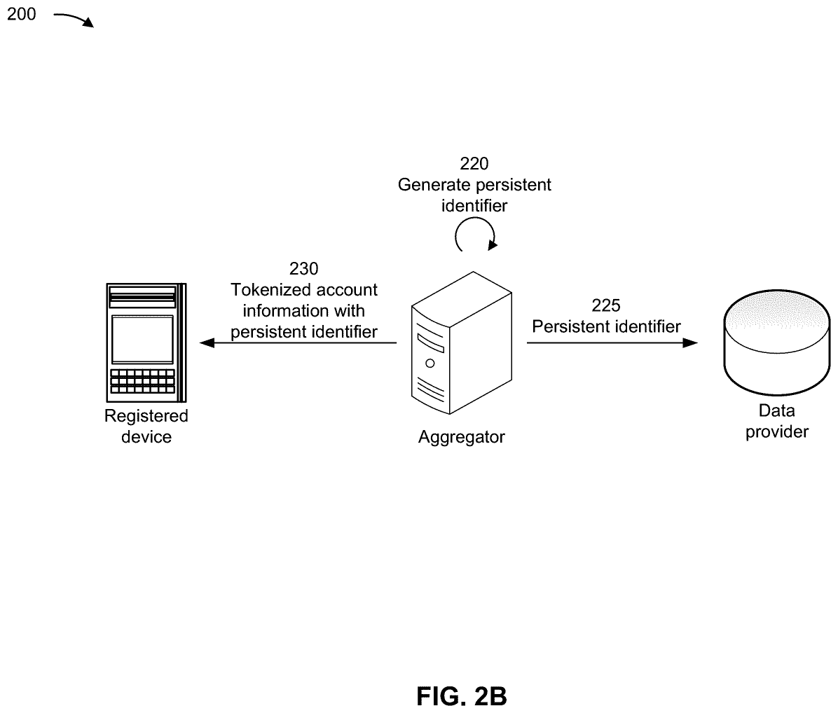

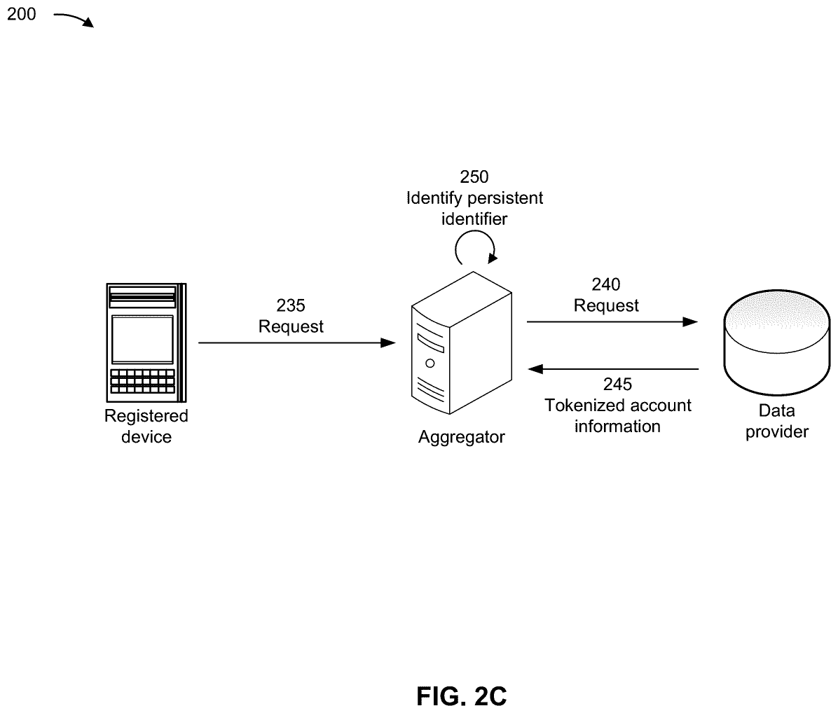

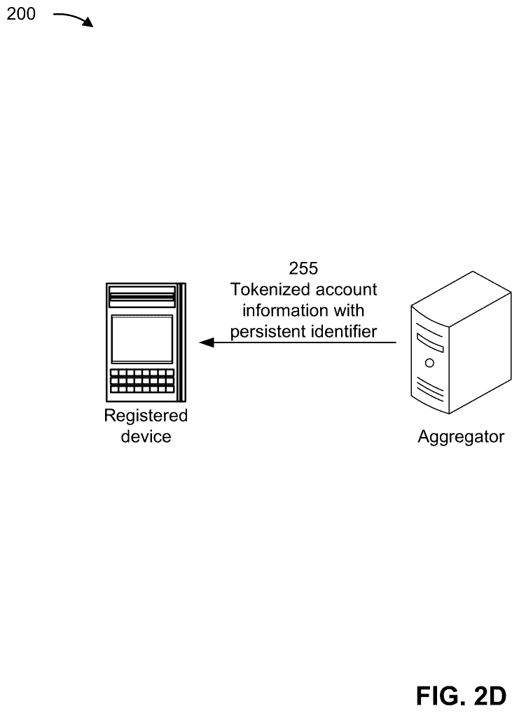

As shown by reference number 120, the tokenizer may transmit, and the registered device may receive, the token. The tokenizer may transmit the token in response to the request from the registered device. In some implementations, the tokenizer may additionally include a persistent identifier, as described in connection with FIGS. 2A-2D. As a result, the registered device may determine when the token is associated with a same account as previous tokens.

The registered device may thus use the token to proceed with the event (e.g., submit the transaction for processing). As shown in FIG. 1B and by reference number 125, the registered device may transmit, and the detokenizer may receive, a NACHA file including the token (or at least the tokenized account information from the token). Although the example 100 is described in connection with the ACH network, other examples may include the registered device transmitting a balance request and/or a request for historical transaction information, among other examples, including the token (or at least the tokenized account information from the token). As shown in FIG. 1B, the detokenizer may receive the NACHA file directly from the registered device (e.g., when the detokenizer is a processing device used by the registered device, as described below). Alternatively, the registered device may transmit the NACHA file to a processing device that forwards the NACHA file along the ACH network to the detokenizer (which may be, for example, an originating data provider, a receiving data provider, or an ACH network device, as described below).

In some implementations, as shown by reference number 130a, the tokenizer may transmit, and the detokenizer may receive, an indication associated with the token. In the example 100, the detokenizer may be a processing device in the network, as described in connection with FIG. 3. Other examples include an originating data provider, a receiving data provider, or an ACH network device, as described in connection with FIG. 3, serving as the detokenizer.

In some implementations, the indication associated with the token indicates a first identifier, included in the token, that is indicative of a second identifier, included in the token, being tokenized. For example, the tokenizer may indicate a tokenized routing number to the detokenizer such that the detokenizer can detect when the NACHA file includes a tokenized account number based on the NACHA file including the tokenized routing number.

Additionally, or alternatively, the indication associated with the token includes a data structure that includes a mapping between the token and the account information. Accordingly, the detokenizer also serves as a token vault that securely stores (e.g., in an encrypted storage) an association between the token (or at least the tokenized account information in the token) and the (detokenized) account information. Therefore, the detokenizer may obtain the account information from the token (e.g., after determining to perform detokenization based on the indication associated with the token). Because the detokenizer can detokenize the account information from the token directly, network overhead is conserved that otherwise would have been expended on communications between the detokenizer and the tokenizer such that the tokenizer detokenizes the account information from the token.

Alternatively, the tokenizer may serve as the token vault. Accordingly, as shown by reference number 130b, the detokenizer may communicate with the tokenizer to detokenize the account information from the token. For example, the detokenizer may transmit, and the tokenizer may receive, a detokenization request including the token (e.g., after determining to perform detokenization based on the indication associated with the token). In response to the detokenization request, the tokenizer may transmit, and the detokenizer may receive, the (detokenized) account information. Because the mapping between the token and the account information is only stored at the tokenizer, security is improved as compared with when the detokenizer receives the data structure that includes the mapping from the tokenizer, such that a bad actor could intercept the data structure.

Although the example 100 is described in connection with the tokenizer or the detokenizer serving as the token vault, other examples may include a third-party device (e.g., a key distribution center (KDC) or another type of remote server or other computing device) serving as the token vault. For example, the tokenizer may transmit the account information to the token vault and receive the token in response, such that the token vault stores the data structure that includes the mapping between the token and the account information. Alternatively, the tokenizer may generate the token, transmit the token and the account information, and discard the account information after transmitting, such that the token vault stores the data structure that includes the mapping and such that the tokenizer refrains from storing the (detokenized) account information. Similarly, the detokenizer may transmit the token to the token vault and receive the account information in response, such that the token vault performs the detokenization. Alternatively, the detokenizer may receive (at least a portion of) the data structure that includes the mapping from the token vault, perform the detokenization, and discard the data structure, such that the detokenizer refrains from storing the mapping.

In some implementations, the token vault may perform verifications (e.g., at least one verification) and/or validations (e.g., at least one validation) before transmitting the account information to the detokenizer. For example, the request from the registered device may indicate a destination account (e.g., using an account number and/or another type of identifier associated with an account) that is associated with the registered device. Additionally, the NACHA file may also indicate a destination account. The token vault may verify the destination account indicated in the request against the destination account indicated in the NACHA file (e.g., verify that the destination accounts are the same). In examples where the detokenizer is at least partially integrated (e.g., physically, logically, and/or virtually) with the token vault, the detokenizer may verify the destination accounts before performing detokenization. In examples where the detokenizer is at least partially separate (e.g., physically, logically, and/or virtually) from the token vault, the detokenizer may verify the destination accounts before transmitting a detokenization request. As a result of verifying the destination accounts, security is further improved. For example, an intercepted token will be rejected when used for a different destination account than originally indicated to the tokenizer, and thus power, processing resources, and network overhead are conserved that would have been spent in undoing a fraudulent transaction with a different destination account.

Additionally, or alternatively, the request from the registered device may indicate an amount (e.g., a dollar amount, such as $20 or $20.12, among other examples) that is associated with the event. Additionally, the NACHA file may also indicate an amount. The token vault may validate the amount indicated in the request against the amount indicated in the NACHA file (e.g., validate that the amounts are the same). In examples where the detokenizer is at least partially integrated (e.g., physically, logically, and/or virtually) with the token vault, the detokenizer may validate the amounts before performing detokenization. In examples where the detokenizer is at least partially separate (e.g., physically, logically, and/or virtually) from the token vault, the detokenizer may validate the amounts before transmitting a detokenization request. As a result of validating the amounts, security is further improved. For example, an intercepted token will be rejected when used for a different amount account than originally indicated to the tokenizer, and thus power, processing resources, and network overhead are conserved that would have been spent in undoing a fraudulent transaction with a different amount.

As shown in FIG. 1C and by reference number 135, the detokenizer may transmit, and a data provider may receive, the account information from the token. For example, the detokenizer may forward the NACHA file with the account information substituted in place of the token. Similarly, the detokenizer may decode the NACHA file and generating a new NACHA file based on information decoded from the NACHA file and the account information from the token. In some implementations, the data provider in FIG. 1C may be an originating data provider, as described below in connection with FIG. 3, and the data provider in FIG. 1A may be a receiving data provider, as described in connection with FIG. 3. Alternatively, the detokenizer may transmit the account information to an ACH network device (e.g., when the detokenizer is the originating data provider, as described above) or to the receiving data provider (e.g., when the detokenizer is an ACH network device, as described above).

As shown by reference number 140, the data provider may transmit, and the tokenizer may receive, a status associated with the event. For example, the data provider may indicate whether the event has proceeded (e.g., whether the transaction has been processed and approved). Additionally, or alternatively, the detokenizer may transmit, and the tokenizer may receive, a status associated with the token. For example, the detokenizer may indicate when the token has been detokenized (e.g., a datetime associated with detokenization). In some implementations, the tokenizer may communicate with the detokenizer to perform detokenization, and thus the tokenizer may store a datetime associated with detokenization without receiving the status from the detokenizer. In some implementations, the token vault may be at least partially separate (e.g., physically, logically, and/or virtually) from the tokenizer and the detokenizer, and the token vault may transmit (and the tokenizer may receive) the status associated with the token (e.g., the datetime associated with detokenization).

In response to detokenization (e.g., transmitting the account information to the detokenizer, receiving a status from the detokenizer and/or the data provider, and/or receiving a status from the token vault), the tokenizer may store an indication that the token is expired, as shown by reference number 145. For example, the indication may ensure that the tokenizer rejects any future detokenization requests that include the token that was used for the event. Additionally, or alternatively, the token vault may store the indication that the token is expired. For example, the tokenizer may transmit, and the token vault may receive, the indication that the token is expired. In another example, the tokenizer may store the indication in response to transmitting the account information to the detokenizer, receiving a status associated with the token from the detokenizer and/or the data provider, and/or receiving a status associated with the token from the tokenizer.

In some implementations, the tokenizer (and/or the token vault) may store an indication that the token is expired based on an amount of time since generation of the token satisfying the expiry threshold. For example, the registered device may refrain from using the token (e.g., refrain from transmitting a NACHA file including the token), or the NACHA file may otherwise be corrupted or fail to process. Accordingly, the token may expire based on the expiry threshold, which further improves security. For example, an intercepted token will be rejected when used after satisfaction of the expiry threshold, and thus power, processing resources, and network overhead are conserved that would have been spent in undoing a fraudulent transaction that used a stale token.

Based on the status received by the tokenizer, the tokenizer may respond to status inquiries from the registered device. For example, the registered device may transmit, and the tokenizer may receive, a status request associated with the token. The status request may include a call to an application programming interface (API) function provided by the tokenizer and including the token (or at least an identifier associated with the token) as a parameter. Accordingly, as shown by reference number 150, the tokenizer may transmit, and the registered device may receive, an indication of whether the token is expired. Additionally, or alternatively, the tokenizer may transmit an indication of a status associated with the token (e.g., whether the event associated with the token has proceeded) based on the status received from the data provider.

By using techniques as described in connection with FIGS. 1A-1C, the tokenizer generates single use tokens that are transparent to the ACH network. For example, the tokenizer may generate tokens that expire after one use (and, optionally, after satisfying a short expiry threshold). As a result, security is improved because the tokens are useless if intercepted. Additionally, power, processing resources, and network overhead are conserved that otherwise would have been spent on undoing fraudulent transactions.

As indicated above, FIGS. 1A-1C are provided as an example. Other examples may differ from what is described with regard to FIGS. 1A-1C.

FIGS. 2A-2D are diagrams of an example 200 associated with generating persistent identifiers. As shown in FIGS. 2A-2D, example 200 includes a registered device, an aggregator, and a data provider. These devices are described in more detail in connection with FIGS. 3 and 4.

As shown in FIG. 2A and by reference number 205, the registered device may transmit, and the aggregator may receive, a request for account information. The request may include a call to an API function (e.g., a call to an accounts endpoint) provided by the aggregator and including an identifier associated with an account (e.g., an account number, an account_id parameter, and/or another type of identifier) as a parameter.

As shown by reference number 210, the aggregator may transmit, and the data provider may receive, the request for the account information. The aggregator may forward the request from the registered device (e.g., directly or by decoding the request and generating a new request based on information decoded from the request) to the data provider. The aggregator may determine the data provider to contact (e.g., an Internet protocol (IP) address and/or another identifier associated with the data provider) by mapping an indication included in the request from the registered device (e.g., a name or another indication associated with the data provider) to the identifier associated with the data provider. Additionally, or alternatively, the aggregator may map a portion of the identifier associated with an account (e.g., a prefix, a midfix, a checksum, or a postfix, among other examples) to the identifier associated with the data provider.

As shown by reference number 215, the data provider may transmit, and the aggregator may receive, a tokenized version of the account information. For example, the data provider may transmit the tokenized version of the account information in response to the request from the aggregator.

In order to allow for tracking across different tokenizations of the account information, the aggregator may generate a persistent identifier, as shown in FIG. 2B and by reference number 220. The persistent identifier may be associated with the account and unique to the aggregator. The persistent identifier is generated by the aggregator and thus is unusable to obtain the account information from the data provider.

As show by reference number 225, the aggregator may transmit, and the data provider may receive, an indication of the persistent identifier. For example, the data provider may agree to include the persistent identifier with future tokenized versions of the account information. Alternatively, the aggregator may map future tokenized versions of the account information to the persistent identifier without indicating the persistent identifier to the data provider.

As shown by reference number 230, the aggregator may transmit, and the registered device may receive, the tokenized version of the account information along with the persistent identifier. For example, the aggregator may transmit the tokenized version of the account information in response to the request from the registered device.

Future responses to the registered device that are associated with a same account will include the same persistent identifier, even when the account information is differently tokenized by the data provider. For example, as shown in FIG. 2C and by reference number 235, the registered device may transmit, and the aggregator may receive, an account request. The account request may include a balance pull and/or a pull of historical transaction information, among other examples. The account request is associated with a same account as the request described in connection with FIG. 2A.

As shown by reference number 240, the aggregator may transmit, and the data provider may receive, the account request. The aggregator may forward the account request from the registered device (e.g., directly or by decoding the account request and generating a new account request based on information decoded from the account request) to the data provider. In response, as shown by reference number 245, the data provider may transmit, and the aggregator may receive, a tokenized version of the account information. The tokenized version of the account information shown in FIG. 2C is different than the tokenized version of the account information shown in FIG. 2A. For example, the data provider may apply a new algorithm, apply a new parameter, and/or otherwise tokenize the account information differently than before.

As shown by reference number 250, the aggregator may identify the persistent identifier based on the tokenized version of the account information. For example, as described above, the data provider may include the persistent identifier with the tokenized version of the account information. Alternatively, the aggregator may use indicia included in the tokenized version of the account information (e.g., a name, a set of transactions, a type of account, and/or a balance, among other examples) to determine that the tokenized version of the account information is associated with a same account as the persistent identifier.

Therefore, as shown in FIG. 2D and by reference number 255, the aggregator may transmit, and the registered device may receive, the tokenized version of the account information along with the persistent identifier. The persistent identifier allows the registered device to determine that the tokenized version of the account information shown in FIG. 2C is associated with a same account as the tokenized version of the account information shown in FIG. 2A.

By using techniques as described in connection with FIGS. 2A-2D, the aggregator generates persistent identifiers to associate with tokenized account information. As a result, the registered device may determine when events (e.g., transactions) are associated with a same account and thus is more likely to proactively detect and prevent fraud (e.g., repeat events or transactions). Therefore, power, processing resources, and network overhead are conserved that otherwise would have been spent on undoing fraudulent transactions. Additionally, security is improved because the persistent identifier is only for informational purposes and is unusable in place of the tokenized account information.

As indicated above, FIGS. 2A-2D are provided as an example. Other examples may differ from what is described with regard to FIGS. 2A-2D.

FIG. 3 is a diagram of an example environment 300 in which systems and/or methods described herein may be implemented. As shown in FIG. 3, environment 300 may include an aggregator 310, a registered device 320, a processing device 330, an originating data provider 340, an ACH network device 350, a receiving data provider 360, and/or a computer network 370. Devices of environment 300 may interconnect via wired connections and/or wireless connections.

The aggregator 310 may include one or more devices capable of receiving, generating, storing, processing, and/or providing information associated with accounts, as described elsewhere herein. The aggregator 310 may receive and store account information from data partners (e.g., the originating data provider 340 and/or the receiving data provider 360). The aggregator 310 may include a communication device and/or a computing device. For example, the aggregator 310 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The aggregator 310 may communicate with one or more other devices of environment 300, as described elsewhere herein.

The registered device 320 may include one or more devices capable of facilitating an event (e.g., an electronic transaction). For example, the registered device 320 may include a point-of-sale (PoS) terminal, a payment terminal (e.g., a credit card terminal, a contactless payment terminal, a mobile credit card reader, or a chip reader), and/or an automated teller machine (ATM). In some implementations, the registered device 320 may include a server associated with electronic transactions (e.g., a cloud-based payment terminal). The registered device 320 may include one or more input components and/or one or more output components to facilitate obtaining data (e.g., account information) from the aggregator 310 and/or to facilitate interaction with and/or authorization from an owner or accountholder. Example input components of the registered device 320 include a network interface card (NIC), a number keypad, a touchscreen, a magnetic stripe reader, a chip reader, and/or a radio frequency (RF) signal reader (e.g., a near-field communication (NFC) reader). Example output components of the registered device 320 include the NIC, a display, and/or a speaker. The registered device 320 may communicate with one or more other devices of environment 300, as described elsewhere herein.

The processing device 330 may include one or more devices capable of processing, authorizing, and/or facilitating a transaction. For example, the processing device 330 may include one or more servers and/or computing hardware (e.g., in a cloud computing environment or separate from a cloud computing environment) configured to receive and/or store information associated with processing an electronic transaction (e.g., a NACHA file or another type of ACH file, among other examples). The processing device 330 may process an event (e.g., a transaction) by directing transaction information to the originating data provider 340. The processing device 330 may communicate with one or more other devices of environment 300, as described elsewhere herein.

The originating data provider 340 may include one or more devices capable of receiving, generating, storing, processing, and/or providing information associated with accounts, as described elsewhere herein. The originating data provider 340 may process events (e.g., transactions) associated with an account managed by the originating data provider 340 (e.g., based on NACHA files or other types of ACH files received from the processing device 330). The originating data provider 340 may include a communication device and/or a computing device. For example, the originating data provider 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The originating data provider 340 may communicate with one or more other devices of environment 300, as described elsewhere herein. In some implementations, the originating data provider 340 may be associated with an originating institution (e.g., an originating financial institution). The originating data provider 340 may be at least partially separate (e.g., virtually, logically, and/or physically) from a core services provider (e.g., a core banking provider) associated with the originating institution. For example, the core services provider may process events associated with the account (e.g., based on NACHA files or other types of ACH files), and the originating data provider 340 may provide, or otherwise communicate with another entity (e.g., the aggregator 310 or the ACH network device 350, among other examples) to perform, tokenization and/or detokenization services (e.g., as described herein).

The ACH network device 350 may include one or more devices capable of receiving, processing, storing, routing, and/or providing traffic (e.g., NACHA files and/or other types of ACH files) in a manner described herein. For example, the ACH network device 350 may include a router, a switch, a hub, a bridge, a reverse proxy, a server (e.g., a proxy server, a cloud server, or a data center server), and/or a similar device. In some implementations, the ACH network device 350 may be associated with The Clearing House® (TCH) Electronic Payments Network (EPN) or the Federal Reserve Bank Automated Clearing House (FedACH). In some implementations, the ACH network device 350 may be a virtual device implemented by one or more computing devices of a cloud computing environment or a data center. The ACH network device 350 may forward NACHA files and/or other types of ACH files from the originating data provider 340 to the receiving data provider 360. In some implementations, the ACH network device 350 may forward the files to another ACH network device for eventual routing to the receiving data provider 360. The ACH network device 350 may communicate with one or more other devices of environment 300, as described elsewhere herein.

The receiving data provider 360 may include one or more devices capable of receiving, generating, storing, processing, and/or providing information associated with accounts, as described elsewhere herein. The receiving data provider 360 may process events (e.g., transactions) associated with an account managed by the receiving data provider 360 (e.g., based on NACHA files or other types of ACH files received from the ACH network device 350). The receiving data provider 360 may include a communication device and/or a computing device. For example, the receiving data provider 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The receiving data provider 360 may communicate with one or more other devices of environment 300, as described elsewhere herein. In some implementations, the receiving data provider 360 may be associated with a receiving institution (e.g., a receiving financial institution). The receiving data provider 360 may be at least partially separate (e.g., virtually, logically, and/or physically) from a core services provider (e.g., a core banking provider) associated with the receiving institution. For example, the core services provider may process events associated with the account (e.g., based on NACHA files or other types of ACH files), and the receiving data provider 360 may provide, or otherwise communicate with another entity (e.g., the aggregator 310 or the ACH network device 350, among other examples) to perform, tokenization and/or detokenization services (e.g., as described herein).

The computer network 370 may include one or more wired and/or wireless networks. For example, the computer network 370 may include a cellular network, a public land mobile network, a local area network, a wide area network, a metropolitan area network, a telephone network, a private network, the Internet, and/or a combination of these or other types of networks. The computer network 370 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with generating event-based tokens transparent to a network. The device 400 may correspond to an aggregator 310, a registered device 320, a processing device 330, an originating data provider 340, an ACH network device 350, and/or a receiving data provider 360. In some implementations, the aggregator 310, the registered device 320, the processing device 330, the originating data provider 340, the ACH network device 350, and/or the receiving data provider 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

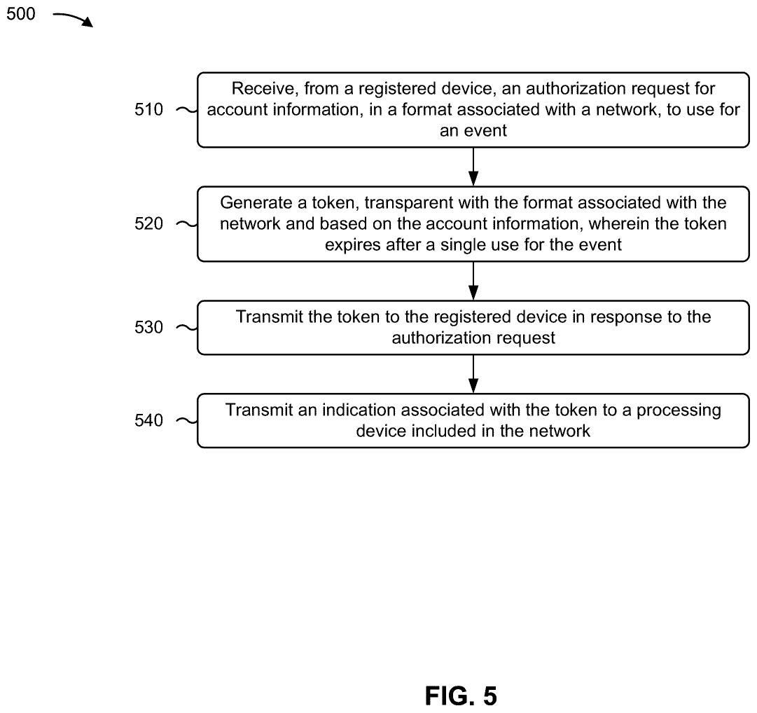

FIG. 5 is a flowchart of an example process 500 associated with generating event-based tokens transparent to a network. In some implementations, one or more process blocks of FIG. 5 may be performed by the tokenizer. In some implementations, one or more process blocks of FIG. 5 may be performed by another device or a group of devices separate from or including the tokenizer, such as the aggregator 310, the registered device 320, the processing device 330, the originating data provider 340, the ACH network device 350, and/or the receiving data provider 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a registered device, an authorization request for account information, in a format associated with a network, to use for an event (block 510). For example, the tokenizer (e.g., using processor 420, memory 430, input component 440, and/or communication component 460) may receive, from a registered device, an authorization request for account information, in a format associated with a network, to use for an event, as described above in connection with reference number 105 of FIG. 1A.

As further shown in FIG. 5, process 500 may include generating a token, transparent to the format associated with the network and based on the account information, wherein the token expires after a single use for the event (block 520). For example, the tokenizer (e.g., using processor 420 and/or memory 430) may generate a token, transparent to the format associated with the network and based on the account information, wherein the token expires after a single use for the event, as described above in connection with reference number 115 of FIG. 1A.

As further shown in FIG. 5, process 500 may include transmitting the token to the registered device in response to the authorization request (block 530). For example, the tokenizer (e.g., using processor 420, memory 430, and/or communication component 460) may transmit the token to the registered device in response to the authorization request, as described above in connection with reference number 120 of FIG. 1A.

As further shown in FIG. 5, process 500 may include transmitting an indication associated with the token to a processing device included in the network (block 540). For example, the tokenizer (e.g., using processor 420, memory 430, and/or communication component 460) may transmit an indication associated with the token to a processing device included in the network, as described above in connection with reference number 130a of FIG. 1B.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIGS. 2A-2D.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating transparent tokens in response to events, the system comprising:
one or more memories; and
one or more processors, communicatively coupled to the one or more memories, configured to:
receive, from a registered device, an authorization request for account information, in a format associated with a network, to use for an event;
generate a token, transparent to the format associated with the network and based on the account information, wherein the token expires after a single use for the event;
transmit the token to the registered device in response to the authorization request;
receive, from a processing device included in the network, a detokenization request including the token;
transmit, to the processing device, the account information in response to the detokenization request; and
store an indication that the token is expired based on transmitting the account information.

2. The system of claim 1, wherein the token further expires based on an expiry threshold of three days or less, and wherein the one or more processors are configured to:
store an indication that the token is expired based on an amount of time since generation of the token satisfying the expiry threshold.

3. The system of claim 1, wherein the one or more processors are configured to:
verify a connection, between the registered device and an account associated with the account information, in response to the authorization request,
wherein the token is generated based on verification of the connection.

4. The system of claim 1, wherein the authorization request indicates a first destination account, the detokenization request indicates a second destination account, and the one or more processors are configured to:
validate the first destination account against the second destination account,
wherein the account information is transmitted based on validation of the first destination account against the second destination account.

5. The system of claim 1, wherein the authorization request indicates a first amount, the detokenization request indicates a second amount, and the one or more processors are configured to:
validate the first amount against the second amount,
wherein the account information is transmitted based on validation of the first amount against the second amount.

6. The system of claim 1, wherein the authorization request indicates an amount, and the one or more processors are configured to:
transmit a balance request to a data provider associated with the account information;
receive, from the data provider, a response to the balance request that indicates a balance associated with the account information; and
validate the amount against the balance,
wherein the token is generated based on validation of the amount against the balance.

7. The system of claim 1, wherein the one or more processors are configured to:
receive, from the registered device, a status request associated with the token; and
transmit, to the registered device and in response to the status request, an indication of a status of the token.

8. A method of generating transparent tokens in response to events, comprising:
receiving, from a registered device, an authorization request for account information, in a format associated with a network, to use for an event;
generating a token, transparent to the format associated with the network and based on the account information, wherein the token expires after a single use for the event;
transmitting the token to the registered device in response to the authorization request; and
transmitting an indication associated with the token to a processing device included in the network.

9. The method of claim 8, wherein the indication associated with the token indicates a first identifier, included in the token, that is indicative of a second identifier, included in the token, being tokenized.

10. The method of claim 8, wherein the indication associated with the token includes a data structure that includes a mapping between the token and the account information.

11. The method of claim 8, wherein the authorization request indicates a destination account, and the indication associated with the token indicates the destination account.

12. The method of claim 8, wherein the authorization request indicates an amount, and the method further comprises:
transmitting a balance request to a data provider associated with the account information;
receiving, from the data provider, a response to the balance request that indicates a balance associated with the account information; and
validating the amount against the balance,
wherein the token is generated based on validation of the amount against the balance.

13. The method of claim 8, further comprising::
receiving, from the registered device, a status request associated with the token; and
transmitting, to the registered device and in response to the status request, an indication of whether the token is expired.

14. The method of claim 8, wherein the network comprises an automated clearing house network.

15. A non-transitory computer-readable medium storing a set of instructions for generating transparent tokens in response to events, the set of instructions comprising:
one or more instructions that, when executed by one or more processors of a device, cause the device to:
generate, for an account, a persistent identifier unique to the device;
receive, from a registered device, a first authorization request for account information, in a format associated with a network, to use for a first event;
generate a first token, transparent to the format associated with the network and based on the account information, wherein the first token expires after a single use for the first event;
transmit the first token to the registered device, in response to the first authorization request, with the persistent identifier;
receive, from the registered device, a second authorization request for the account information, in the format associated with the network, to use for a second event;
generate a second token, transparent with the format associated with the network and based on the account information, wherein the second token expires after a single use for the second event; and
transmit the second token to the registered device, in response to the first authorization request, with the persistent identifier.

16. The non-transitory computer-readable medium of claim 15, wherein the one or more instructions, when executed by the one or more processors, cause the device to:
receive, from the registered device, an account request; and
transmit, to the registered device, a response to the account request indicating the account information with the persistent identifier.

17. The non-transitory computer-readable medium of claim 15, wherein the one or more instructions, when executed by the one or more processors, cause the device to:
transmit, to a data provider associated with the account information, an indication of the persistent identifier.

18. The non-transitory computer-readable medium of claim 15, wherein the one or more instructions, when executed by the one or more processors, cause the device to:
transmit an indication associated with the first token to a processing device included in the network.

19. The non-transitory computer-readable medium of claim 15, wherein the one or more instructions, when executed by the one or more processors, cause the device to:
receive, from a processing device included in the network, a detokenization request including the first token; and
transmit, to the processing device, the account information in response to the detokenization request.

20. The non-transitory computer-readable medium of claim 15, wherein the format associated with the network comprises a national automated clearing house association format.
